(19) United States
(12) Patent Application Publication
(10) Pub. No.: US 2024/0365291 A1
(43) Pub. Date: Oct. 31, 2024

(54) METHOD AND SYSTEM FOR SENSING SIGNAL HANDLING

(71) Applicant: Rohde & Schwarz GmbH & Co. KG, Muenchen (DE)

(72) Inventors: Lilei WANG, Muenchen (DE); Meik KOTTKAMP, Muenchen (DE); Juergen SCHLIENZ, Muenchen (DE)

(73) Assignee: Rohde & Schwarz GmbH & Co. KG, Muenchen (DE)

(21) Appl. No.: 18/306,539

(22) Filed: Apr. 25, 2023

(51) Int. Cl. H04W 72/044

(52) U.S. Cl. CPC H04W 72/044

(57) ABSTRACT

Embodiments of the present disclosure relate to a method of sensing signal handling. A sensing signal transmission procedure is triggered by a transmitting node or a receiving node. A sensing signal is transmitted the transmitting node, which is received by the receiving node. In case the transmitting node triggers the sensing signal transmission procedure, the transmitting node sends a request including a configuration of the sensing signal to the receiving node, the transmitting node asks the receiving node to receive the sensing signal based on the configuration, and the transmitting node transmits the sensing signal based on the configuration. In case the receiving node triggers the sensing signal transmission procedure, the receiving node sends a request including a suitable configuration of the sensing signal to the transmitting node, and the transmitting node transmits the sensing signal based on the suitable configuration to the receiving node.

### FIELD OF THE DISCLOSURE

Embodiments of the present disclosure relate to a method of sensing signal handling. Further, embodiments of the present disclosure relate to a system for sensing signal handling.

### BACKGROUND

With current mobile network standards, for instance 5G or 5G-NR, objects can be controlled remotely via a respective network. New applications or services concern remote control and/or augmented/virtual reality, generally called extended reality—XR. Right now, these applications or services are mainly used in smaller restricted networks, particularly in industrial and commercial contexts.

With the advent of 6G, using remote control shall be made widely available to end consumers that use a user equipment. Application scenarios include controlling robots that take care of day-to-day tasks, coordinating drones, coordinated autonomous driving as well as affordable, universally accessible augmented and virtual reality.

A core capability introduced by 6G will be the symbiosis between mobile communication and mobile sensing. The participants of the 6G network, generally called nodes, must record their respective surroundings, particularly in 3D, while using sensors, for instance radar, spectroscopy and/or localization sensors. Furthermore, the participants must communicate with each other over the mobile networks in order to exchange data, particularly sensing results obtained.

However, it is impossible to do sensing within the network in an appropriate manner if a receiving node receives sensing signals from different transmitting nodes. Up to now, only self-transmitting and self-receiving nodes are applicable according to which the same node transmits a sensor signal to an object and receives the sensor signal from the object.

Accordingly, there is a need for sensing signal handling that ensures proper sensing within the network.

### SUMMARY

Embodiments of the present disclosure provide a method of sensing signal handling. In an embodiment, the method comprises the steps of triggering a sensing signal transmission procedure by a transmitting node or a receiving node, transmitting a sensing signal by the transmitting node, and receiving the sensing signal by the receiving node. In cases where the transmitting node triggers the sensing signal transmission procedure, the transmitting node sends a request including a configuration of the sensing signal to the receiving node, the transmitting node asks the receiving node to receive the sensing signal based on the configuration, and the transmitting node transmits the sensing signal based on the configuration. Alternatively, in cases where the receiving node triggers the sensing signal transmission procedure, the receiving node sends a request including a suitable configuration of the sensing signal to the transmitting node, and the transmitting node transmits the sensing signal based on the suitable configuration to the receiving node.

Further, embodiments of the present disclosure relate to a system for sensing signal handling. In an embodiment, the system comprises a transmitting note and a receiving node. The transmitting node transmits a sensing signal. The receiving node receives the sensing signal. The transmitting node or the receiving node triggers a sensing signal transmission procedure. In cases where the transmitting node triggers the sensing signal transmission procedure, the transmitting node sends a request including a configuration of the sensing signal to the receiving node, the transmitting node asks the receiving node to receive the sensing signal based on the configuration, and the transmitting node transmits the sensing signal based on the configuration. Alternatively, in cases where the receiving node triggers the sensing signal transmission procedure, the receiving node sends a request including a suitable configuration of the sensing signal to the transmitting node, and the transmitting node transmits the sensing signal based on the suitable configuration to the receiving node.

The main idea is to ensure in an easy and efficient way that the receiving node gets aware of the sensing signal in advance, for example in case the receiving node and the transmitting node are different nodes. This can be ensured since, when the transmitting node triggers the sensing signal transmission procedure, the transmitting node transmits the configuration of the sensing signal to the receiving node such that the receiving node obtains the respective information and can adapt internal settings with respect to the configuration obtained. Hence, the receiving node can prepare itself for receiving the sensing signal. When the receiving node triggers the sensing signal transmission procedure, the receiving node sends a suitable configuration to which the receiving node is configured for receiving the sensing signal. The transmitting node that receives the suitable configuration adapts its own setting for generating the sensing signal accordingly such that the sensing signal transmitted by the transmitting node corresponds to the suitable configuration of the receiving node. Again, it is ensured that the receiving node is prepared for receiving the sensing signal.

According to aspects of the disclosure, it is ensured that the receiving node is already enabled to receive the sensing signal prior to the transmission of the sensing signal due to the exchange of configuration information about the sensing signal.

This procedure is more efficient and easy compared to methods requiring a large signaling overhead.

Accordingly, the configuration of the sensing signal is effected by the node that triggers the sensing signal transmission procedure.

Consequently, a signaling mechanism of sensing signal transmission is defined, which is used for interaction between transmitting node and receiving node, for example in case these nodes are different nodes.

In accordance with another aspect of the present disclosure, the node triggering the sensing signal transmission procedure is, for example, the node that configures the sensing signal. Accordingly, the node that initiates the sensing signal transmission procedure is the one that also provides the respective information about the sensing signal such that the sensing signal is configured accordingly. As indicated above, the respective node may be the transmission node that forwards information about the sensing signal to the receiving node in advance. Alternatively, the receiving node may also trigger the sensing signal transmission procedure by forwarding information about a configuration for the sensing signal to the respective transmission node, which can be processed by the receiving node.

Another aspect provides that the configuration of the sensing signal includes, for example, bandwidth, sequence, waveform, and/or periodicity of the sensing signal. The sensing signal may be defined by any one of the above-mentioned parameters. The respective node triggering the sensing signal transmission procedure may forward the parameter(s) to the other node accordingly.

Alternatively or additionally, the configuration of the sensing signal may include information about a time and/or frequency resource for the sensing signal. The respective node triggering the sensing signal transmission procedure may also forward information about the time and/or frequency resource(s) used for receiving the sensing signal to the other node in order to inform the other node accordingly. The other node may adapt its time and/or frequency resources accordingly.

In some embodiments, the time and/or frequency resource may comprise a carrier index, a physical resource block (PRB) level configuration in frequency domain and/or a symbol level configuration in a time slot. Thus, the respective information may be exchanged in order to ensure that the receiving node is enabled to adapt its configuration accordingly. Alternatively or additionally, the transmitting node adapts its configuration for generating the sensing signal accordingly.

According to another aspect, the configuration of the sensing signal is based on, for example, a priority of an underlying sensing service. In general, several different sensing services may be provided by the system wherein these sensing services have different priorities, for instance due to different resolutions. Depending on the priority of the sensing service, a different configuration of the sensing signal is used, for example a different allocation of time and/or frequency resource(s). In some embodiments, it is ensured that the other node obtains information about the priority of the underlying sensing service directly.

For instance, more resources, e.g. time and/or frequency resource(s), may be allocated for a sensor signal transmission of an underlying sensing service that requires higher resolution. An underlying sensing service requiring a higher resolution may be a sensing service of higher priority. Therefore, more resources may be allocated in order to ensure that the sensing signal associated with the underlying sensing service is prioritized highly.

Generally, the transmitting node and the receiving node may be located in different positions. The respective nodes may be part of a joint communication and sensing system (JCAS system) that comprises several (mobile) nodes.

In some embodiments, the transmitting node or the receiving node may be a base station or a user equipment. In some embodiments, the transmitting node may be either a base station or a user equipment. Irrespective of the type of transmitting node, the receiving node may be a base station or a user equipment. Hence, two base stations or two user equipment may be used. However, one base station and one user equipment may also be used.

Another aspect provides that the node triggering the sensing signal transmission procedure is, for example, the node that defines handling of the sensing signal received, for example the sensing results obtained. Accordingly, the respective node also defines how the sensing results are handled by the nodes involved, for example the transmitting node and the receiving node.

For instance, in case the transmitting node triggers the sensing signal transmission procedure, the transmitting node defines if the receiving node receives the sensing signal and implements a sensing algorithm or if the receiving node receives the sensing signal and feedbacks the sensing signal received or information derived from the sensing signal received back to the transmitting node that implements the sensing algorithm. Accordingly, the transmitting node triggering the sensing signal transmission procedure may also determine if it is the receiving node that analyzes the sensing signal, thereby providing the sensing results, namely by applying the sensing algorithm. Alternatively, the transmitting node triggering the sensing signal transmission procedure may determine that the receiving node that only feedbacks the sensing signal or information derived therefrom to the transmitting node, as the transmitting node itself implements the sensing algorithm that is used for obtaining the sensing results.

In case the receiving node triggers the sensing signal transmission procedure, the receiving node may define if the receiving node receives the sensing signal and implements a sensing algorithm or if the receiving node receives the sensing signal and feedbacks the sensing signal received or information derived from the sensing signal received back to the transmitting node that implements the sensing algorithm. In case the receiving node is the one that triggers a sensing signal transmission procedure, the receiving node is the node that determines how to handle the sensing signal received, for example which node determines the sensing results. As indicated above, the receiving node may determine which of the nodes involved is the one that gathers the sensing results by applying the sensing algorithm to the sensing signal accordingly.

For a base station or user equipment which transmits and receives the sensing signal by itself, it is up to the base station or user equipment about how to configure the sensing signal and relevant resources, for instance in time and/or frequency domain.

However, the embodiments of the present disclosure overcome the problem how to configure the sensing signal and coordinate the sensing resources in case the sensing signal is received by a node, namely the receiving node, which is different to the node that transmits the sensing signal, namely the transmitting node. So far, it was impossible to do sensing if the receiver does not know sensing signal or relevant resource in advance. The embodiments of the present disclosure overcome this issue.

In some embodiments, the transmitting node transmits the sensing signal and the receiving node receives the sensing signal while the transmitting node and the receiving node are located at different positions.

The configuration of the sensing signal is up to the node triggering the sensing signal transmission procedure, namely either the transmitting node or the receiving node.

In case the receiving node triggers the sensing signal transmission procedure, it sends a request to the transmitting node and provides a preferable configuration for the sensing signal. Then, the transmitting node transmits the sensing signal according to the preferable configuration that corresponds to a suitable configuration.

In case the transmitting node triggers the sensing signal transmission procedure, the transmitting node sends a request including a sensing signal configuration to the receiving node and asks the receiving node to receive the sensing signal based on the configuration submitted.

For instance, the (suitable/preferable) configuration may include parameters like bandwidth, sequence, waveform and/or periodicity of the sensing signal. Moreover, the configuration may include information about the time and/or frequency resources, e.g. carrier index, physical resource block (PRB) level configuration and/or symbol level configuration.

Generally, the configuration of the sensing signal may also be based on priority of sensing service, e.g. the allocation of time and/or frequency resources. In some embodiments, more resources may be allocated to the sensing signal transmission for a particular sensing service, e.g. in case the particular sensing service requires a higher resolution. Consequently, the particular sensing service would have a higher priority.

Additionally, it is also up the node triggering the sensing signal transmission procedure how the sensing signal is handled, for example the sensing results obtained.

In cases where transmitting node triggers the sensing signal transmission procedure, the transmitting node decides if: (1) the receiving node receives the sensing signal and implements the sensing algorithm, or (2) the receiving node just receives the sensing signal and feedbacks the received sensing signal or a quantity derived thereof, e.g. its quality, to the transmitting node, which implements the sensing algorithm.

In cases where receiving node triggers the sensing procedure, it decides if: (1) the receiving node receives the sensing signal and implements the sensing algorithm, or (2) the receiving node just receives the sensing signal and feedbacks the received sensing signal or a quantity derived thereof, e.g. its quality, to the transmitting node, which implements the sensing algorithm.

The node receiving the (suitable) configuration of the sensing signal may coordinate the sensing signal and (time and/or frequency) resources accordingly, while confirming the configuration of the sensing signal to the node forwarding the (suitable) configuration of the sensing signal. Accordingly, the other node gets aware of the fact that the node receiving the (suitable) configuration of the sensing signal is ready for receiving the sensing signal with the configuration upon which the nodes agreed.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an overview of a system according to an embodiment of the present disclosure,

FIG. 2 schematically shows an overview illustrating a method of sensing signal handling according to a first embodiment of the present disclosure,

FIG. 3 schematically shows an overview illustrating a method of sensing signal handling according to a second embodiment of the present disclosure,

FIG. 4 schematically shows an overview illustrating a method of sensing signal handling according to a third embodiment of the present disclosure, and

FIG. 5 schematically shows an overview illustrating a method of sensing signal handling according to a fourth embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

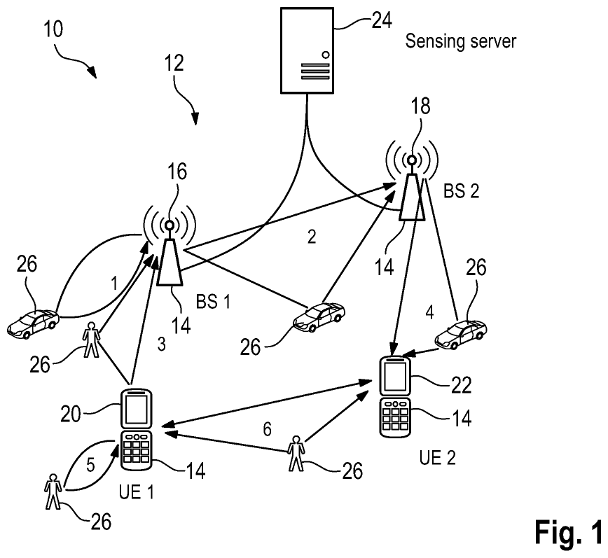

In FIG. 1, a representative joint communication and sensing (JCAS) system 10 is shown that comprises a network 12 with several nodes 14. In the shown embodiment, the nodes 14 correspond to a first base station 16 (“BS1”), a second base station 18 (“BS2”), a first user equipment 20 (“UE1”) and a second user equipment 22 (“UE2”). The joint communication and sensing system 10, for example the network 12, comprises a sensing server 24 that is connected with the base stations 16, 18. The joint communication and sensing (JCAS) reference objects 26 are shown in FIG. 1, which relate to vehicles or persons. The respective nodes 14 may correspond to transmitting nodes and/or receiving nodes, which depends on a respective sensing mode applied.

FIG. 1 illustrates six different sensing modes that are indicated by the numbers “1” to “6” as well as the respective arrows between the nodes 14 and the JCAS reference objects 26. Each mode will be described in more detail below.

In a first mode “1”, the transmitting node is the first base station 16 that transmits a sensing signal to the JCAS object 26, e.g. a vehicle, and simultaneously receives the sensing signal from the JCAS object 26. Hence, the first base station 16 is also the receiving node.

In a second mode “2”, the transmitting node is the first base station 16 that transmits the sensing signal, for example to the JCAS object 26, e.g. a vehicle. The receiving node is the second base station 18 that is located at a different position compared to the first base station 16. The second base station 18 acting as the receiving node receives the sensing signal from the JCAS object 26 as well as directly from the first base station 16 acting as the transmitting node.

In a third mode “3”, the transmitting node is the first user equipment 20 that transmits the sensing signal, for example to the JCAS object 26, e.g. a person. The receiving node is the first base station 16. The first base station 16 acting as the receiving node receives the sensing signal from the JCAS object 26 as well as directly from the first user equipment 20 acting as the transmitting node.

In a fourth mode “4”, the transmitting node is the second base station 18 that transmits the sensing signal, for example to the JCAS object 26, e.g. a vehicle. The receiving node is the second user equipment 22. The second user equipment 22 acting as the receiving node receives the sensing signal from the JCAS object 26 as well as directly from the second base station 18 acting as the transmitting node.

In a fifth mode “5”, the transmitting node is the first user equipment 20 that transmits a sensing signal to the JCAS object 26, e.g. a person, and simultaneously receives the sensing signal from the JCAS object 26. Hence, the first user equipment 20 is also the receiving node.

In a sixth mode “6”, the transmitting node is the first user equipment 20 that transmits the sensing signal, for example to the JCAS object 26, e.g. a person. The receiving node is the second user equipment 22 that is located at a different position compared to the first user equipment 20. The second user equipment 22 acting as the receiving node receives the sensing signal from the JCAS object 26 as well as directly from the first user equipment 20 acting as the transmitting node.

Accordingly, the base stations 16, 18 as well as the user equipment 20, 22 may act as the sensing node. As shown, the nodes 14, namely the transmitting node and the receiving node, are located in different positions.

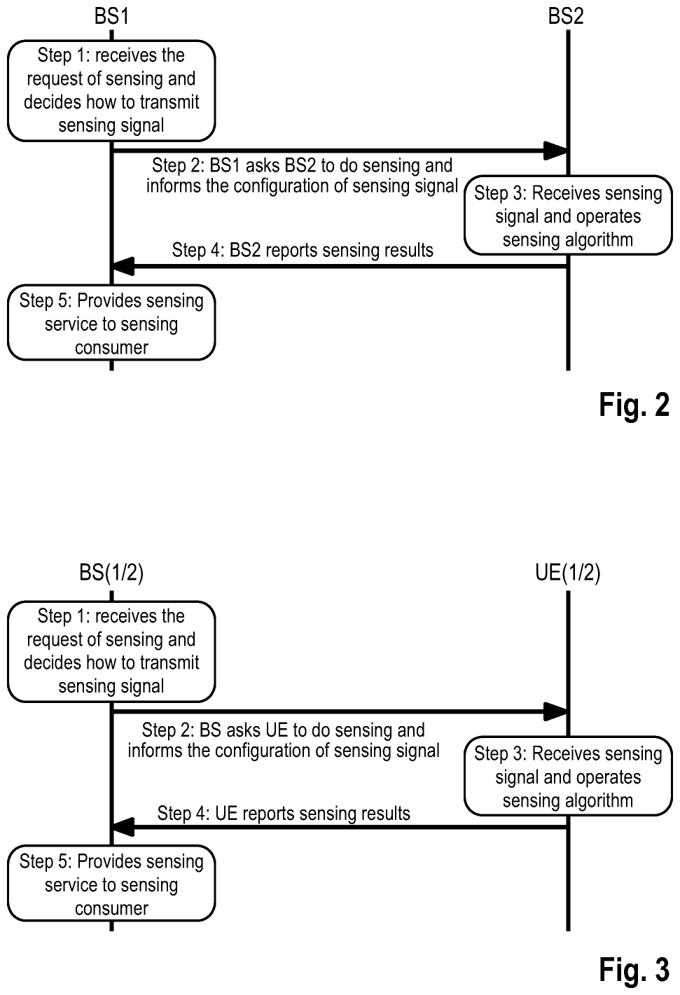

In FIG. 2, a first embodiment of a method of sensing signal handling is shown. In this example embodiment, the first base station 16 is the transmitting node and the second base station 18 is the receiving node.

In a first step, the first base station 16 receives a request of sensing from the sensing server 24. The first base station 16 decides how to transmit the sensing signal. Actually, the first base station 16 decides on its own or the first base station 16 is controlled by the sensing server 24 accordingly.

In a second step, the first base station 16 asks the second base station 18 to do the sensing, e.g. receiving the sensing signal. Therefore, the first base station 16 informs the second base station 18 about the configuration to be used for the sensing signal.

The second base station 18 processes the configuration of the sensing signal received from the first base station 16. Accordingly, the second base station 18 sets internal configurations appropriately, thereby ensuring that the second base station 18 is enabled to receive the sensor signal.

Therefore, the second base station 18 is ready for performing the sensing, namely receiving the sensing signal transmitted by the first base station 16.

Accordingly, the second base station 18 receives the sensing signal and also implements or applies a sensing algorithm in order to analyze the sensing signal received. Thus, the second base station 18 obtains sensing results.

In a fourth step, the sensing results obtained are reported to the first base station 16.

In a fifth step, the first base station 16 that was asked by the sensing server 24 provides the sensing results associated with the sensing service to a sensing consumer.

Generally, the first base station 16 when asking the second base station 18 to perform the sensing may also defines that the receiving node, namely the second base station 18, receives the sensing signal and implements the sensing algorithm.

Alternatively, the receiving node, namely the second base station 18, receives the sensing signal and feedbacks the sensing signal received or information derived from the sensing signal received back to the transmitting node, namely the first base station 16. The first base station 16, namely the transmitting node, implements the sensing algorithm in order to obtain the sensing results.

Accordingly, the first base station 16 is the node that triggers the sensing signal transmission procedure, as the first base station 16 asks the second base station 18 for sensing. The first base station 16 is also the node that transmits the sensing signal such that the first base station 16 is the transmitting node.

The first base station 16 informs the second base station 18 that is the receiving node about the configuration of the sensing signal. This gives the second base station 18 the opportunity to set its configuration accordingly.

In addition, the first base station 16 that is the node that triggers the sensing signal transmission procedure also defines that the receiving node, namely the second base station 18, shall apply the sensing algorithm on the sensing signal received in order to gather the sensing results that are fed back to the first base station 16.

In a second embodiment of the method that is shown in FIG. 3, the node that triggers the sensing signal transmission procedure relates to a certain base station, for instance the first base station 16 or the second base station 18, whereas the receiving node relates to a user equipment, for instance the first user equipment 20 or the second user equipment 22.

Accordingly, a base station and a user equipment correspond to the transmitting node and the receiving node, respectively. This is the only difference from the first embodiment shown in FIG. 2.

Accordingly, the base station, e.g. the first base station 16 or the second base station 18, is the node that triggers the sensing signal transmission procedure, as the respective base station 16, 18 asks the user equipment for sensing, namely receiving the sensing signal. The user equipment may be the first user equipment 20 or the second user equipment 22. The respective base station 16, 18 is also the node that transmits the sensing signal such that the respective base station 16, 18 is the transmitting node.

The respective base station 16, 18 informs the respective user equipment 20, 22 that is the receiving node about the configuration of the sensing signal. This gives the respective user equipment 20, 22 the opportunity to set its configuration accordingly. In addition, the respective base station 16, 18 that is the node that triggers the sensing signal transmission procedure also defines that the receiving node, namely the respective user equipment 20, 22, shall apply the sensing algorithm on the sensing signal received in order to gather the sensing results that are fed back to the respective base station 16, 18.

As indicated above, the respective base station 16, 18 that is the node that triggers the sensing signal transmission procedure may also define that the receiving node, namely the respective user equipment 20, 22, shall only feedback the sensing signal received or information derived from the sensing signal received back to the respective base station 16, 18, namely the transmitting node. The respective base station 16, 18 implements or applies the sensing algorithm in order to obtain the sensing results.

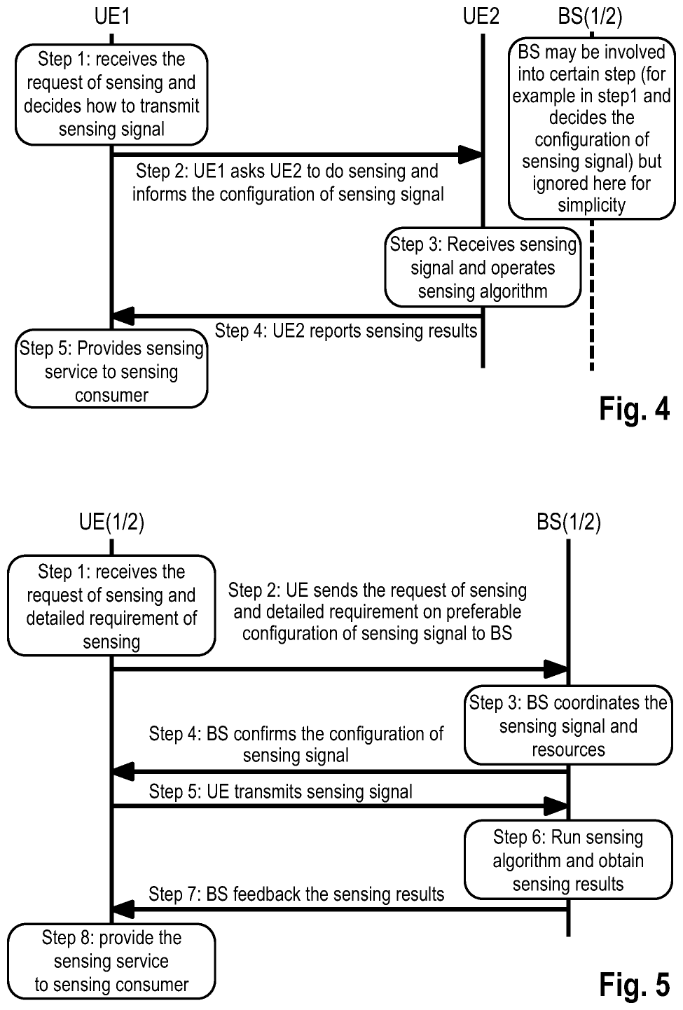

In FIG. 4, a third embodiment of the method of sensing signal handling is shown, wherein the node that triggers the sensing signal transmission procedure is the first user equipment 20, which also corresponds to the transmitting node. The receiving node corresponds to the second user equipment 22. Irrespective of this difference, the third embodiment corresponds to the first and second embodiment described with reference to FIGS. 2 and 3.

Accordingly, the first user equipment 20 is the node that triggers the sensing signal transmission procedure, as the first user equipment 20 asks the second user equipment 22 for sensing, namely receiving the sensing signal. The first user equipment 20 is also the node that transmits the sensing signal such that the first user equipment 20 is the transmitting node.

The first user equipment 20 informs the second user equipment 22 that is the receiving node about the configuration of the sensing signal. This gives the second user equipment 22 the opportunity to set its configuration accordingly. In addition, the first user equipment 20 that is the node that triggers the sensing signal transmission procedure also defines that the receiving node, namely the second user equipment 22, shall apply the sensing algorithm on the sensing signal received in order to gather the sensing results that are fed back to the first user equipment 20.

As indicated above, the first user equipment 20 that is the node that triggers the sensing signal transmission procedure may also define that the receiving node, namely the second user equipment 22, shall only feedback the sensing signal received or information derived from the sensing signal received back to the first user equipment 20, namely the transmitting node. The first user equipment 20 implements or applies the sensing algorithm in order to obtain the sensing results.

In addition, it is shown in FIG. 4 that a base station, for instance the first base station 16 or the second base station 18, may be involved into certain steps, for instance in step 1 in order to also decide how the configuration of the sensing signal shall be. For example, the sensing server 24 connected to the base stations 16, 18 may also control how the configuration of the sensing signal shall be while controlling at least one of the base stations 16, 18 accordingly. However, the involvement of the base station(s) 16, 18 and/or the sensing server 24 is optional and can be ignored in the third embodiment for simplicity.

In a fourth embodiment of the method that is shown in FIG. 5, a user equipment, for instance the first user equipment 20 or the second user equipment 22, relates to the node 14 that triggers the sensing signal transmission procedure. In this specific case, the respective user equipment 20, 22 receives from the sensing server 24 (directly or indirectly via a base station) the request of sensing, for instance together with a detailed requirement of sensing.

In a second step, the respective user equipment 20, 22 sends a request for sensing and a suitable configuration of the sensing signal to the other node 14, for instance the first base station 16 or the second base station 18.

In a third step, the respective base station 16, 18 coordinates the sensing signal and resources accordingly, for instance time and/or frequency resources.

In a fourth step, the respective base station 16, 18 confirms the configuration of the sensing signal to the respective user equipment 20, 22. Then, the respective user equipment 20, 22 gets aware that the respective user equipment 20, 22 is configured for receiving the sensing signal.

In a fifth step, the respective user equipment 20, 22 transmits the sensing signal towards the respective base station 16, 18 (via a JCAS object 26) that is configured to receive the sensing signal due to its configuration set.

In a sixth step, the respective base station 16, 18 runs the sensing algorithm on the sensing signal received, thereby obtaining the sensing results.

In a seventh step, the sensing results obtained are fed back to the respective user equipment 20, 22.

In an eighth step, the respective user equipment 20, 22 provides the sensing results, namely the sensing service, to a sensing consumer.

Alternatively to steps 4 and 5, the respective base station 16, 18 may configure itself such that the respective base station 16, 18 sends the sensing signal with a configuration corresponding to the suitable configuration obtained previously. Hence, the respective user equipment 20, 22 receives the sensing signal.

The respective user equipment 20, 22 may apply the sensing algorithm on its own and forwards the sensing results to the respective base station 16, 18. Alternatively, the respective user equipment 20, 22 only forwards the sensing signal received or information derived from the sensing signal received back to the respective base station 16, 18 that runs the sensing algorithm on the sensing signal received in order to obtain the sensing results.

Generally, the node 14 triggering the sensing signal transmission procedure is the node 14 that also configures the sensing signal, e.g. sets the configuration of the sensing signal.

The configuration of the sensing signal includes bandwidth, sequence, waveform and/or periodicity of the sensing signal. Moreover, the configuration of the sensing signal also includes information about a time and/or frequency resource for the sensing signal, for instance a carrier index, a physical resource block (PRB) level configuration in frequency domain and/or a symbol level configuration in a time slot.

The respective node 14, for example the receiving node 14, may set its internal configuration accordingly, thereby ensuring that the receiving node 14 is enabled to receive the sensing signal.

As discussed above, the node 14 triggering the sensing signal transmission procedure is the node 14 that defines handling of the sensing signal received. This may be the transmitting node 14 or the receiving node 14.

In cases where the transmitting node 14 triggers the sensing signal transmission procedure, the transmitting node 14 defines if the receiving node 14 receives the sensing signal and implements the sensing algorithm or if the receiving node 14 receives the sensing signal and feedbacks the sensing signal received or information derived from the sensing signal received back to the transmitting node 14 that implements the sensing algorithm.

In cases where the receiving node 14 triggers the sensing signal transmission procedure, the receiving node 14 defines if the receiving node 14 receives the sensing signal and implements the sensing algorithm or if the receiving node 14 receives the sensing signal and feedbacks the sensing signal received or information derived from the sensing signal received back to the transmitting node 14 that implements the sensing algorithm.

Hence, it does not matter which node 14 triggers the sensing signal transmission procedure, e.g. the transmitting node 14 or the receiving node 14, as it is the node 14 triggering the sensing signal transmission procedure that also defines the handling of the sensing signal received.

In cases where an underlying sensing service has a higher priority, for instance due to a sensing service requiring a higher resolution, the respective configuration of the sensing signal takes care thereof. Hence, more (time and/or frequency) resources are allocated for the sensor signal transmission of this underlying sensing service.

Certain embodiments disclosed herein include systems, apparatus, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof.

In an embodiment, circuitry includes hardware circuit implementations (e.g., implementations in analog circuitry, implementations in digital circuitry, and the like, and combinations thereof). In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implemented the functionality or methodology described herein.

Various embodiments of the present disclosure or the functionality thereof may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably). Such non-transitory computer-readable storage media include all computer-readable media (including volatile and non-volatile media).

Embodiments of the present disclosure, or components thereof, may also take the form of an apparatus, system, computing device, computing entity, and/or the like executing instructions stored on computer-readable storage media to perform certain steps or operations. The computer-readable media include cooperating or interconnected computer-readable media, which exist exclusively on a processing or processor system or distributed among multiple interconnected processing or processor systems that may be local to, or remote from, the processing or processor system. However, embodiments of the present disclosure, or components thereof, may also take the form of an entirely hardware embodiment performing certain steps or operations.

Various embodiments are described above with reference to block diagrams and/or flowchart illustrations of apparatuses, methods, systems, and/or computer program instructions or program products. It should be understood that each block of any of the block diagrams and/or flowchart illustrations, respectively, or portions thereof, may be implemented in part by computer program instructions, e.g., as logical steps or operations executing on one or more computing devices. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein.

These computer program instructions may also be stored in one or more computer-readable memory or portions thereof, such as the computer-readable storage media described above, that can direct one or more computers or computing devices or other programmable data processing apparatus(es) to function in a particular manner, such that the instructions stored in the computer-readable memory produce an article of manufacture including computer-readable instructions for implementing the functionality specified in the flowchart block or blocks.

The computer program instructions may also be loaded onto one or more computers or computing devices or other programmable data processing apparatus(es) to cause a series of operational steps to be performed on the one or more computers or computing devices or other programmable data processing apparatus(es) to produce a computer-implemented process such that the instructions that execute on the one or more computers or computing devices or other programmable data processing apparatus(es) provide operations for implementing the functions specified in the flowchart block or blocks and/or carry out the methods described herein.

It will be appreciated that the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof.

Accordingly, blocks of the block diagrams and/or flowchart illustrations support various combinations for performing the specified functions, combinations of operations for performing the specified functions and program instructions for performing the specified functions. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In some embodiments, the network 12, the nodes 14, etc., or components thereof, are configured to perform one or more method steps of the claimed subject matter. In some embodiments, one or more of these components includes one or more computer-readable media containing computer readable instructions embodied thereon that, when executed by one or more computer circuits, sometimes referred to as computing devices, cause the one or more computer circuits to perform one or more method steps of the claimed subject matter. In some embodiments, the one or more computer circuits includes a microprocessor, a microcontroller, a central processing unit, a graphics processing unit (GPU), a digital signal processor (DSP), an ASIC, etc.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method of sensing signal handling, comprising the steps of:
triggering a sensing signal transmission procedure by a transmitting node or a receiving node;
transmitting a sensing signal by the transmitting node;
receiving the sensing signal by the receiving node; wherein
in case the transmitting node triggers the sensing signal transmission procedure, the transmitting node sends a request including a configuration of the sensing signal to the receiving node, the transmitting node asks the receiving node to receive the sensing signal based on the configuration, and the transmitting node transmits the sensing signal based on the configuration, or
in case the receiving node triggers the sensing signal transmission procedure, the receiving node sends a request including a suitable configuration of the sensing signal to the transmitting node, and the transmitting node transmits the sensing signal based on the suitable configuration to the receiving node.

2. The method according to claim 1, wherein the node triggering the sensing signal transmission procedure is the node that configures the sensing signal.

3. The method according to claim 1, wherein the configuration of the sensing signal includes at least one of bandwidth, sequence, waveform and periodicity of the sensing signal.

4. The method according to claim 1, wherein the configuration of the sensing signal includes information about a time and/or frequency resource for the sensing signal.

5. The method according to claim 4, wherein the time and/or frequency resource comprises at least one of a carrier index, a physical resource block (PRB) level configuration in frequency domain and a symbol level configuration in a time slot.

6. The method according to claim 1, wherein the configuration of the sensing signal is based on a priority of an underlying sensing service.

7. The method according to claim 1, wherein more resources are allocated for sensor signal transmission of an underlying sensing service that requires higher resolution.

8. The method according to claim 1, wherein the transmitting node and the receiving node are located in different positions.

9. The method according to claim 1, wherein the node triggering the sensing signal transmission procedure is the node that defines handling of the sensing signal received.

10. The method according to claim 9, wherein
in case the transmitting node triggers the sensing signal transmission procedure, the transmitting node defines if the receiving node receives the sensing signal and implements a sensing algorithm or if the receiving node receives the sensing signal and feedbacks the sensing signal received or information derived from the sensing signal received back to the transmitting node that implements the sensing algorithm; or
in case the receiving node triggers the sensing signal transmission procedure, the receiving node defines if the receiving node receives the sensing signal and implements a sensing algorithm or if the receiving node receives the sensing signal and feedbacks the sensing signal received or information derived from the sensing signal received back to the transmitting node that implements the sensing algorithm.

11. A system for sensing signal handling, comprising:
a transmitting node and a receiving node, wherein the transmitting node transmits a sensing signal, wherein the receiving node receives the sensing signal, wherein the transmitting node or the receiving node triggers a sensing signal transmission procedure, and wherein
in case the transmitting node triggers the sensing signal transmission procedure, the transmitting node sends a request including a configuration of the sensing signal to the receiving node, the transmitting node asks the receiving node to receive the sensing signal based on the configuration, and the transmitting node transmits the sensing signal based on the configuration; or
in case the receiving node triggers the sensing signal transmission procedure, the receiving node sends a request including a suitable configuration of the sensing signal to the transmitting node, and the transmitting node transmits the sensing signal based on the suitable configuration to the receiving node.

12. The system according to claim 11, wherein the node triggering the sensing signal transmission procedure is the node that configures the sensing signal.

13. The system according to claim 11, wherein the configuration of the sensing signal includes at least one of bandwidth, sequence, waveform, time, frequency and periodicity of the sensing signal, and/or wherein the configuration of the sensing signal includes a time and/or frequency resource of the sensing signal.

14. The system according to claim 11, wherein the transmitting node or the receiving node is a base station or a user equipment.

15. The system according to claim 11, wherein the configuration of the sensing signal is based on a priority of an underlying sensing service.

16. The system according to claim 11, wherein more resources are allocated for sensor signal transmission of an underlying sensing service that requires higher resolution.

17. The system according to claim 11, wherein the transmitting node and the receiving node are located in different positions.

18. The system according to claim 11, wherein the node triggering the sensing signal transmission procedure is the node that defines handling of the sensing signal received.

19. The system according to claim 18, wherein
in case the transmitting node triggers the sensing signal transmission procedure, the transmitting node defines if the receiving node receives the sensing signal and implements a sensing algorithm or if the receiving node receives the sensing signal and feedbacks the sensing signal received or information derived from the sensing signal received back to the transmitting node that implements the sensing algorithm; or
in case the receiving node triggers the sensing signal transmission procedure, the receiving node defines if the receiving node receives the sensing signal and implements a sensing algorithm or if the receiving node receives the sensing signal and feedbacks the sensing signal received or information derived from the sensing signal received back to the transmitting node that implements the sensing algorithm.
